(19) United States
(12) Patent Application Publication
(10) Pub. No.: US 2024/0224027 A1
(43) Pub. Date: Jul. 4, 2024

(54) NETWORK AWARENESS OF ATSSS CAPABLE DEVICES BY UE SIGNALING

(71) Applicant: CABLE TELEVISION LABORATORIES, INC., Louisville, CO (US)

(72) Inventors: SUNDAR R. SRIRAM, AURORA, IL (US); YUNGJUNG YI, Vienna, VA (US)

(21) Appl. No.: 18/090,166

(22) Filed: Dec. 28, 2022

Related U.S. Application Data
(60) Provisional application No. 63/273,316, filed on Oct. 29, 2021.
(60) Provisional application No. 63/278,141, filed on Nov. 11, 2021.
(60) Provisional application No. 63/278,144, filed on Nov. 11, 2021.

(51) Int. Cl. H04W 8/24

(52) U.S. Cl. CPC H04W 8/24; H04W 88/06

(57) ABSTRACT

Systems, methods, and devices include techniques for allocating network resources and/or improving network usage. A method includes sending by a wireless device to one or more radio access networks (RAN)s connecting to a core network, a first indication that the wireless device has an Access Traffic Steering, Switching, and Switching (ATSSS) capability. The first indication is included in at least one of: a UECapabilityInformation message of a user equipment (UE) Capabilities Transfer procedure; or a UEAssistanceInformation message of a UE assistance information capability procedure. Additionally, the method receives a second indication of network resource allocation in response to sending the first indication. The second indication configures, on the core network, carrier aggregation for the wireless device.

### CROSS-REFERENCE TO RELATED APPLICATION

This application claims priority under 35 U.S.C. § 119 to U.S. Provisional Patent Application No. 63/273,316, titled “NETWORK AWARENESS OF ATSSS CAPABLE DEVICES BY UECAPABILITYINFORMATION SIGNALING” and filed Oct. 29, 2021; U.S. Provisional Patent Application No. 63/278,141, titled “ACCESS TRAFFIC SPLITTING AND CA COORDINATION FOR OPTIMIZATION OF UE BATTERY LIFE AND NETWORK RESOURCES” and filed Nov. 11, 2021; and U.S. Provisional Patent Application No. 63/278,144, titled “NETWORK AWARENESS OF ATSSS CAPABLE DEVICES BY UE ASSISTANCE INFORMATION SIGNALING” and filed Nov. 11, 2021, the entireties of which are incorporated herein by reference.

### BACKGROUND

Many mobile devices support Access Traffic Steering, Switching, and Splitting (ATSSS), which can be used to steer, split, or switch radio access traffic between multiple radio access networks (RAN)s. However, various network functions (NF) are outside the ATSSS framework thus limiting their ability to use the ATSSS framework.

It is with these observations in mind, among others, that the presently disclosed technology was conceived.

### BRIEF SUMMARY

The aforementioned problems can be addressed using the systems, methods, and devices disclosed herein. For instance, a method of allocating network resources can include sending, by a wireless device to one or more radio access networks (RAN)s connecting to a core network, a first indication that the wireless device has an Access Traffic Steering, Switching, and Switching (ATSSS) capability. The first indication can be included in at least one of: a UECapabilityInformation message of a user equipment (UE) Capabilities Transfer procedure; or a UEAssistanceInformation message of a UE assistance information capability procedure. The method can additionally include receiving a second indication of network resource allocation in response to sending the first indication.

In some examples, the method further comprises receiving, by the wireless device, a UECapabilityEnquiry message, wherein the first indication that the wireless device has the ATSSS capability is included in the UECapabilityInformation message responsive to the UECapabilityEnquiry message. Furthermore, the method can comprise receiving, by the wireless device, an RCCReconfiguration message, wherein the first indication that the wireless device has the ATSSS capability is included in the UEAssistanceInformation message responsive to the RCCReconfiguration message. Additionally or alternatively, the one or more RANs includes a first RAN of a multi-access packet data unit (MA PDU) session and/or a second RAN of the MA PDU session, the first RAN being a third generation partnership program (3GPP) RAN and the second RAN being a non-3GPP RAN; and/or sending the first indication of the ATSSS capability can be responsive to releasing the wireless device from the MA PDU session. Moreover, the first indication of the ATSSS capability can include an indication the wireless device has an Access Traffic Steering capability. The first indication the wireless device has the Access Traffic Steering capability can include an indication the wireless device has multi-path transmission control protocol (MPTCP) functionality for transmission control protocol (TCP) traffic. The first indication the wireless device has the Access Traffic Steering capability can also include an indication the wireless device has ATSSS-lower level (LL) functionality for transmission control protocol (TCP) traffic, user datagram protocol (UDP) traffic, or Ethernet traffic.

In some instances, the first indication of the ATSSS capability includes an indication the wireless device has an Access Traffic Switching capability. Additionally or alternatively the first indication of the ATSSS capability includes an indication the wireless device has an Access Traffic Splitting capability. Furthermore, the first indication of the ATSSS capability can include one or more additional information elements (IE)s included in the UECapabilityInformation message based on a first standard of third generation partnership program (3GPP) TS 38.331: Section 5.6.1 or a second standard of long term evolution (LTE) 36.331 Section 5.6.3. Moreover, the wireless device can include multiple universal subscriber identity modules (USIM)s, and the one or more additional IEs can consolidate ATSSS features for the multiple USIMS. Receiving the second indication of network resource allocation can also include performing Carrier Aggregation (CA) configuration and/or activation for the wireless device.

In some examples, a method of allocating network resources comprises receiving, from a wireless device and at one or more radio access networks (RAN)s connecting to a core network, a first indication that the wireless device has an ATSSS capability. The first indication can be included in at least one of: a UECapabilityInformation message of a user equipment (UE) Capabilities Transfer procedure; or a UEAssistanceInformation message of a UE assistance information capability procedure. The method can also include sending a second indication of network resource allocation in response to receiving the first indication.

In some instances, the method further includes sending, from the one or more RANs and to a session management function (SMF) or a policy control function (PCF), a query to check policies of a service data unit (SDU) or a packet data unit (PDU) data flow for the wireless device; and/or determining, by the one or more RANs or an Access & Mobility Function (AMF), the ATSSS capability for the wireless device based at least partly on a response to the query. Additionally, the first indication of the ATSSS capability can be included in a FeatureGroupIndicator (FGI) of the UECapabilityInformation message. In some examples, such as those including 5G-(New Radio) NR systems, the first indication of the ATSSS capability can be included in a Feature Set for carrying UE capability information. A 6G system can use another type of UE capability information message/procedure for indicating the ATSSS capability. Furthermore, the first indication of the ATSSS capability can include an indication of a Performance Measurement Function (PMF) at a user plane function (UPF) associated with ATSSS-lower level (LL) functionality. In some scenarios, the first indication is included in the UECapabilityInformation message with one or more of: an increment/decrement in a connected mode discontinuous reception (DRX) cycle length; overheating assistance information; in-device coexistence (IDC) assistance information; a preference of a DRX parameter; a preference of a maximum aggregated bandwidth; a preference of a maximum number of secondary component carriers; a preference of a maximum number of multiple-input multiple-output (MIMO) layers; a preference of a minimum scheduling offset for cross-slot scheduling; a preference of a radio resource control (RRC) state; configured grant assistance information for a new radio (NR) sidelink communication; or a preference of being provisioned with reference time information.

In some examples, a method of allocating network resources comprises receiving, from a wireless device and at a 3GPP RAN connecting to a core network, a first indication that the wireless device has an ATSSS capability. The method can also include receiving, from the wireless device and at a non-3GPP RAN connecting to the core network, a second indication that the wireless device has the ATSSS capability; and/or sending, from the 3GPP RAN or the non-3GPP RAN and in response to receiving the first indication or the second indication, a third indication of network resource allocation for configurating, on the core network, carrier aggregation (CA) for the wireless device. In some scenarios, the first indication or the second indication includes an RRCConnectionReconfigruationComplete message indicating the ATSSS capability. Moreover, the method can further include, in response to the RRCConnectionReconfigruationComplete message indicating the ATSSS capability, activating an ATSSS feature instead of a CA feature for a call associated with the wireless device.

The foregoing summary is intended to be illustrative and is not meant in a limiting sense. Many features of the examples may be employed with or without reference to other features of any of the examples. Additional aspects, advantages, and/or utilities of the presently disclosed technology will be set forth in part in the description that follows and, in part, will be apparent from the description, or may be learned by practice of the presently disclosed technology.

### BRIEF DESCRIPTION OF THE DRAWINGS

The foregoing summary, as well as the following detailed description, will be better understood when read in conjunction with the appended drawings. For the purpose of illustration, there is shown in the drawings certain examples of the disclosed subject matter. It should be understood, however, that the disclosed subject matter is not limited to the precise examples and features shown. The accompanying drawings, which are incorporated in and constitute a part of this specification, illustrate implementations of systems, methods, and devices consistent with the disclosed subject matter and, together with the description, serves to explain advantages and principles consistent with the disclosed subject matter, in which:

FIG. 1 illustrates an example system including a UE signaling an ATSSS capability in a multi-RAN network environment;

FIG. 2 illustrates an example system including an ATSSS capability signaling UE having steering functionalities, which can form at least a portion of the system depicted in FIG. 1;

FIG. 3A illustrates an example system including a protocol stack of a performance measurement function (PMF), which can from at least a portion of the system depicted in FIG. 1;

FIG. 3B illustrates an example system including a UE/User Plane Function (UPF) measurements related protocol stack 302 for non-3GPP access, which can form at least a portion of the system depicted in FIG. 1;

FIG. 4 illustrates an example system including ATSSS operations of the ATSSS capability signaling UE and other network functions, which can form at least a portion of the system depicted in FIG. 1;

FIGS. 5A and 5B illustrate an example system including one or more UE Capability mechanisms for the UE to signal the ATSSS capability to a RAN, which can form at least a portion of the system depicted in FIG. 1;

FIGS. 6A-6C illustrate an example system including a UE Assistance Information Capability framework to indicate the ATSSS capability to the RAN, which can form at least a portion of the system depicted in FIG. 1;

FIG. 7 illustrates an example system including a carrier aggregation (CA) procedure based on the network receiving the indication of ATSSS capabilities from a UE, which can form at least a portion of the system depicted in FIG. 1;

FIGS. 8A and 8B illustrate an example system including an updated carrier aggregation procedure for a UE with ATSSS capabilities, which can form at least a portion of the system depicted in FIG. 1;

FIG. 9 illustrates an example method for allocating network resources with an ATSSS capability signaling UE, which can be performed by the system depicted in FIG. 1; and

FIG. 10 illustrates an example method for allocating network resources, including carrier aggregation resources, with an ATSSS capability signaling UE, which can be performed by the system depicted in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts may be exaggerated to better illustrate details and features of the present disclosure.

The phraseology and terminology employed herein are for the purpose of description and should not be regarded as limiting. For example, the use of a singular term, such as, “a” is not intended as limiting of the number of items. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to examples of many different forms, it is intended that the present disclosure be considered as an example of the principles of the presently disclosed technology and not intended to limit the presently disclosed technology to the specific examples shown and described. Any one of the features of the presently disclosed technology may be used separately or in combination with any other feature. References to the terms “examples,” and/or the like in the description mean that the feature and/or features being referred to are included in, at least, one aspect of the description. Separate references to the terms “example,” “examples,” and/or the like in the description do not necessarily refer to the same example and are also not mutually exclusive unless so stated and/or except as will be readily apparent to those skilled in the art from the description. For example, a feature, structure, process, step, action, or the like described in one example may also be included in other examples, but is not necessarily included. Thus, the presently disclosed technology may include a variety of combinations and/or integrations of the examples described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. The terms “comprising,” “including” and “having” are used interchangeably in this disclosure. The terms “comprising,” “including” and “having” mean to include, but not necessarily be limited to the things so described.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

Systems, methods, and devices disclosed herein can address the aforementioned issues by using various communication procedures to make the RAN nodes and/or the core network aware of the of the ATSSS Capability of the UE, which efficiently uses radio resources and optimizes the user experience. Some mechanisms for the UE to signal to the RAN its ATSSS capability and status can leverage enhancements to the UE Assistance framework. For instance, one or more additional Information Element (IEs) can be used in a UECapabilityInformation message to enable the UE to explicitly signal its ATSSS capability to the network. Additionally or alternatively, enhancements can be made to the UE Assistance Information Capability framework as described in 3GPP TS 38.331: Section 5.7.4. to enable the UE to signal its ATSSS capability and status to the RAN. In some scenarios, the RAN or the Access & Mobility Function (AMF) can indirectly deduce the ATSSS activation on the device by checking the policies configured for the data flow (a service data unit (SDU) session or a packet data unit (PDU) session), for instance, by querying the SMF and PCF. In response to receiving the indication of the ATSSS capability of the wireless device (e.g., by storing an indication of the ATSSS capability associated with a wireless device identifier in a database), the NFs can send one or more indications of network allocation, such as activating a carrier aggregation (CA) for the wireless device and/or configuring the CA for the wireless device.

Additional benefits and advantages of the presently disclosed technology will become apparent from the detailed description below.

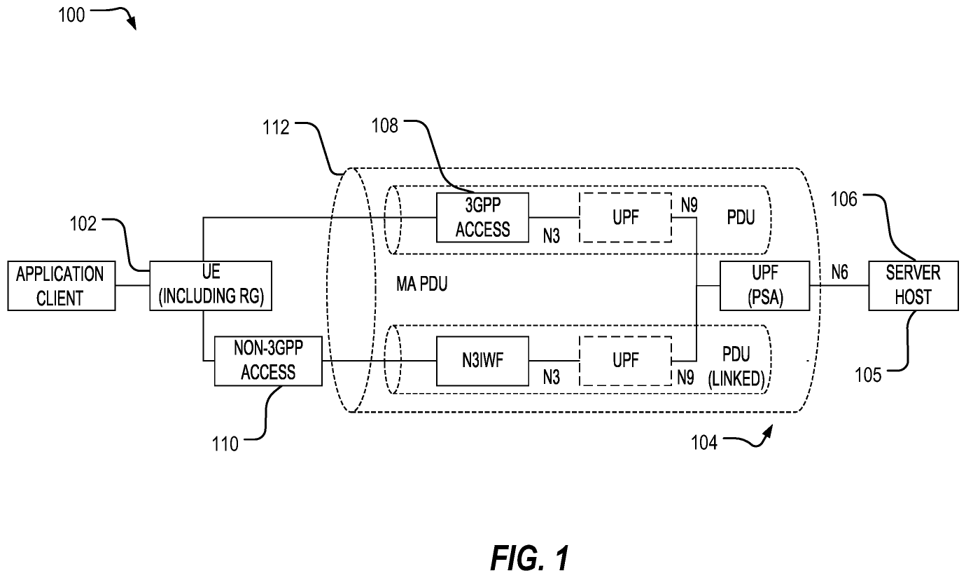

FIG. 1 illustrates an example network system 100 including an ATSSS capability signaling UE 102 (e.g., “the UE 102”) in a multi-RAN network environment 104. Using the techniques disclosed herein, the ATSSS capability signaling UE 102 can have an ATSSS feature which enables a multi-access PDU Connectivity Service to exchange PDUs between the ATSSS capability signaling UE 102 and a data network or core network 105 (e.g., including a server host 106). As such, the UE 102 can effectively make use of one 3GPP access network 108 and one non-3GPP access network 110 simultaneously. Additionally, the techniques disclosed herein can be used with two different 3GPP access networks (e.g., two 5G RAN nodes, two 4G RAN nodes, a 4G Ran node and a 5 G RAN node), or two different non-3GPP access networks. In some scenarios, the ATSSS capability signaling UE 102 can use two independent N3/N9 tunnels between the two independent packet data unit session anchors (PSA)s (e.g., a user plane function (UPF)) and two RAN or Access Node (AN)s. The multi-access PDU Connectivity Service can include establishing a Multi-Access PDU (MA PDU) Session 112, which can be a PDU Session with user-plane resources on two different access networks, such as the 3GPP access network 108 and the non-3GPP access network 110.

In some examples, the ATSSS capability which the UE 102 signals can include one or more of Access Traffic Steering, Access Traffic Switching, and/or Access Traffic Splitting. Access Traffic Steering can be a capability of selecting an access network for a new data flow and/or transferring the traffic of this data flow over the selected access network. Access traffic steering can be applicable between the one 3GPP access 108 and the one non-3GPP access 110. Access Traffic Switching can be a capability of moving all traffic of an ongoing data flow from one access network to another access network (e.g., from the 3GPP access network 108 to the non-3GPP access network 110) in a way that maintains the continuity of the data flow. Access Traffic Splitting can be a capability of splitting the traffic of a data flow across multiple access networks (e.g., between the 3GPP access network 108 and the non-3GPP access network 110). When traffic splitting is applied to a data flow, some traffic of the data flow is transferred via one access and some other traffic of the same data flow is transferred via another access.

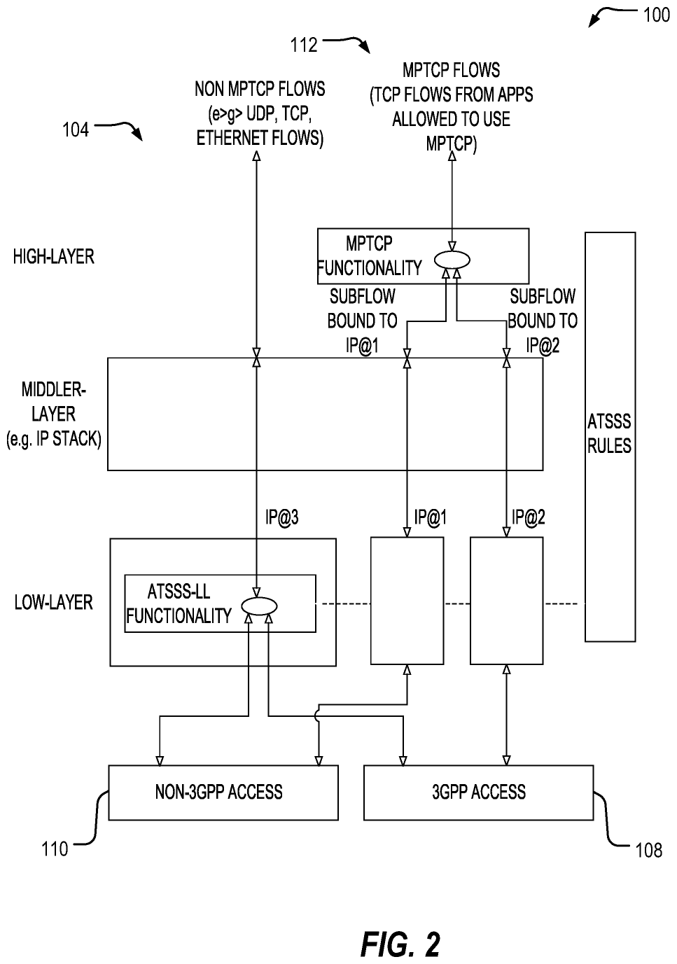

FIG. 2 illustrates the example system 100 including the ATSSS capability signaling UE 102. The system 100, as shown in FIG. 2, can have various ATSSS steering functionalities within the ATSSS capability signaling UE 102.

In some examples, the system 100 can include various ATSSS features indicated by the ATSSS capability signaling UE 102, which can be supported in Release 16 for the multi-access PDU session 112. The Multi-access PDU Session 112 can be a PDU Session providing a PDU connectivity service, which can use one access network at a time, or simultaneously the one 3GPP access network 108 and the one non-3GPP access network 110 and/or two independent N3/N9 tunnels between the two independent PSAs (e.g., the UPF) and the RAN/ANs. In some scenarios, after the establishment of a MA PDU Session 112, and/or if there are user-plane resources established on both access networks, the ATSSS capability signaling UE 102 can apply network-provided policy (e.g., ATSSS rules derived by UE's serving an SMF based on ATSSS policy from a serving PCF) and can consider local conditions (such as network interface availability, signal loss conditions, user preferences, etc.) for deciding how to distribute the uplink traffic across the two access networks. Similarly, a UPF anchor of the MA PDU Session 112 can apply network-provided policy (e.g., N4 rules derived by UE's serving SMF based on ATSSS policy from serving PCF) and the feedback information received from the UE via the user-plane (such as access network Unavailability or Availability). The UPF of the core network 105 can then decides how to distribute the downlink traffic across the two N3/N9 tunnels and two access networks. In some instances, when there are user-plane resources on only one access network, the UE applies the ATSSS rules and considers local conditions for triggering the establishment or activation of the user plane resources over another access. The type of a MA PDU Session 112 may be one of the following types: i.e. IPv4, IPV6, IPv4v6, and Ethernet.

In some examples, these various ATSSS features can be indicated by the ATSSS capability signaling UE 102. These ATSSS features can be supported over 3GPP and/or non-3GPP accesses, including untrusted and/or trusted non-3GPP access networks, wireline 5G access networks, etc., as long as a MA PDU Session 112 can be established over the given type of access network. Furthermore, two ATSSS steering functionalities can be supported and/or indicated by the ATSSS capability signaling UE 102: multi-path transmission control protocol (MPTCP) functionality, for TCP traffic, with MPTCP proxy in UPF, by using the MPTCP protocol over the 3GPP and/or the non-3GPP user plane; and/or ATSSS-lower level (LL) functionality for all types of traffic, including TCP traffic, user datagram protocol (UDP) traffic, Ethernet traffic, etc. Additionally, the ATSSS-LL functionality can be used for a MA PDU Session 112 of an Ethernet type.

In some instances, a Performance Measurement Function (PMF) is supported by the UPF and is specific for ATSSS-LL functionality, if enabled. In accordance with the Release 16, the PMF can support two types of measurements between the ATSSS capability signaling UE 102 and the UPF to assist access selection: the UE 102 and the UPF making round-trip time (RTT) measurements per access when the “Smallest Delay” steering mode is used; and/or the ATSSS capability signaling UE 102 can report access availability/unavailability to the UPF.

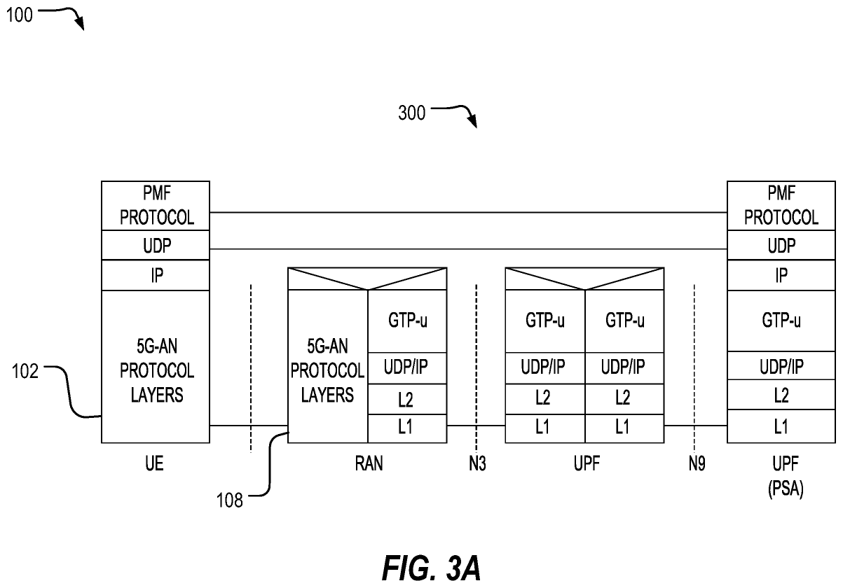

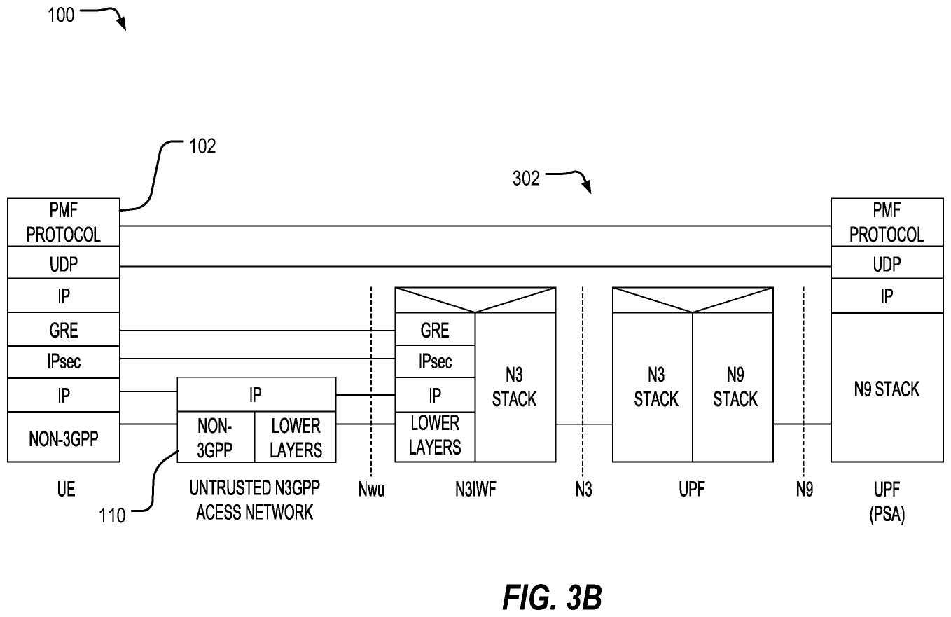

FIG. 3A illustrates the example system 100 with the protocol stacks 300 of the PMF for the user plane measurements over the 3GPP access. FIG. 3 depicts the UE/UPF measurements related protocol stack for 3GPP access and for the MA PDU Session 112 with a type IP. In the case of an MA PDU Session 112 with type Ethernet, the protocol stack over 3GPP access can be that shown in FIG. 3, but with the PMF protocol operating on top of Ethernet, instead of UDP/IP.

FIG. 3B illustrates the example system 100 with a UE/UPF measurements related protocol stack 302 for non-3GPP access and for an MA PDU Session 112 with type IP.

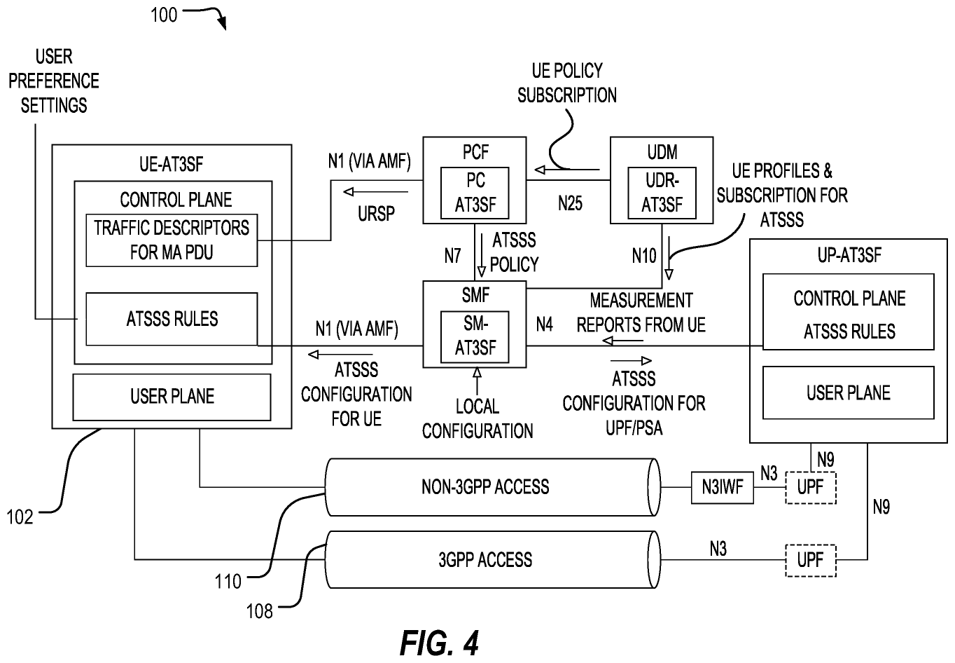

In a scenario including the MA PDU Session 112 with type Ethernet, the protocol stack over non-3GPP access can be as shown in FIG. 4, but with the PMF protocol operating on top of Ethernet, instead of UDP/IP. Furthermore, the ATSSS-capable UE 102 may decide to request a MA PDU Session 112 based on provisioned UE route selection policy (URSP) rules. In particular, the UE can request a MA PDU Session when the UE applies a URSP rule, which triggers the ATSSS capability signaling UE 102 to establish a new PDU Session and the Access Type Preference component of the URSP rule can indicate “Multi-Access.”

Furthermore, a 5G Quality of Service (QOS) model for the Single-Access PDU Session can also be applied to the MA PDU Session 112, such that the QoS Flow is the finest granularity of QoS differentiation in the MA PDU Session 112. One difference of the MA PDU Session 112 compared to the Single-Access PDU Session is that in a MA PDU Session there can be separate user-plane tunnels between the AN and the PSA, each one associated with a different access. The SMF can provide the same QoS flow identifier (QFI) in 3GPP and non-3GPP accesses so that the same QoS is supported in both accesses. Non-Guaranteed Bit Rate (GBR) QoS Flow can be distributed over 3GPP access and non 3GPP access, but GBR QoS Flow can be transferred over single access. In scenarios where ATSSS is not supported, such as when moving to EPC from 5GC, the techniques disclosed herein may be deployed. The techniques may also be used in specific cases with wireline access integrated to evolved packet core (EPC)/5G core (5GC) with 5G-residential gateway (RG); and/or scenarios including ATSSS with one User Plane leg in evolved-universal mobile telecommunications systems (UMTS) Terrestrial Radio Access (E-UTRA)/EPC and one User Plane leg in wireline/5GC supported.

FIG. 4 illustrates example ATSSS operations of the ATSSS capability signaling UE 102, the UPF, the SMF and the PCF, which can be performed and/or indicated by the system 100. FIG. 4 illustrates a system where ATSSS has no or minimal impact on the RAN or the AMF, prior to the signaling from the UE 102. In order for the RAN to efficiently utilize radio resources and optimize the user experience, it can be informed of the ATSSS Capability of the ATSSS capability signaling UE 102. Additionally or alternatively, the RAN/AMF can determine (e.g., indirectly deduce) the ATSSS activation on the device, and corresponding capability of the ATSSS capability signaling UE 102, by checking the policies configured for the data flow (SDU or PDU session) from the SMF and PCF, such as by querying the SMF and PCF, and/or by determining an occurrence of any of the ATSSS related operations discussed herein.

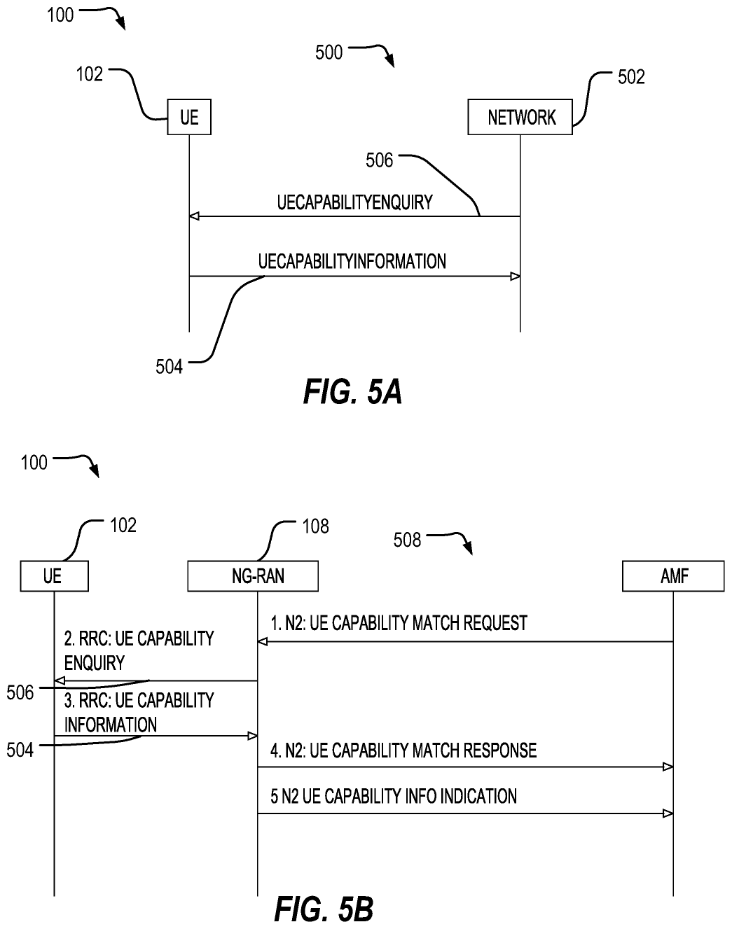

FIGS. 5A and 5B illustrate the system 100 with one or more mechanism(s) for the ATSSS capability signaling UE 102 to signal to the RAN and/or data network its ATSSS capability. For instance, the ATSSS capability signaling UE 102 can use the Capability Transfer framework as described in 3GPP TS 38.331: Section 5.6.1 (LTE 36.331 Section 5.6.3). In some instance, an additional Information Element (IEs) in the UECapabilityInformation message 504 can be generated and/or sent from the ATSSS capability signaling UE 102 to explicitly signal its ATSSS capability. When more than one USIM is active in the UE, one or more additional IEs may consolidate all the ATSSS enhancements supported for the multiple USIMS.

FIG. 5A UE illustrates an examples system 100 using the Capabilities Transfer Framework 500 to indicate the ATSSS capability of the ATSSS capability signaling UE 102 to the RAN 502. For instance, the ATSSS capability signaling UE 102 can send the UECapabilityInformation message 504, including the ATSSS capability indication, in response to a UECapabilityEnquiry message 506 from the RAN. In some scenarios, If the ATSSS capability signaling UE 102 has changed its radio access capabilities after establishing communication, the ATSSS capability signaling UE 102 can request higher layers to initiate the necessary NAS procedures (e.g., based on the TS 23.401 3GPP standard) that would result in the update of UE radio access capabilities using a new RRC connection.

In some instances, the UE Capability Information 504 mostly carries the pure physical layer capability (e.g., UE-Category, Supported Bands, Carrier Aggregation, combinations thereof, etc.). In scenarios including 5G-NR systems, the indication of the ATSSS capability can be included in a Feature Set for carrying UE capability information. Furthermore, a 6G system can use another type of UE capability information message/procedure for indicating the ATSSS capability. Additionally or alternatively, the FeatureGroupIndicator (FGI) can be used to indicate the ATSSS capability (e.g., for 4G-LTE systems). The FGI can be a special IE within UE Capability Information message to carry information about Radio protocol aspects. For example, support for packet switch (PS) Handover, transmission time interval (TTI) bundling, Semi-Persistent Scheduling, Handover between frequency division duplexing (FDD) and time division duplexing (TDD), etc. can be indicated by the FGI bits (e.g., based on TS 36.331 Annex B and Annex C), and/or combined with or include the indication of the ATSSS capability.

FIG. 5B illustrates the example system 100 leveraging the UE Capability Match Request procedure 508 (e.g., at the AMF in 5G scenarios) to request and/or receive an indication of the UE ATSSS capability (e.g., based on TS 23.502 Section 4.2.8a).

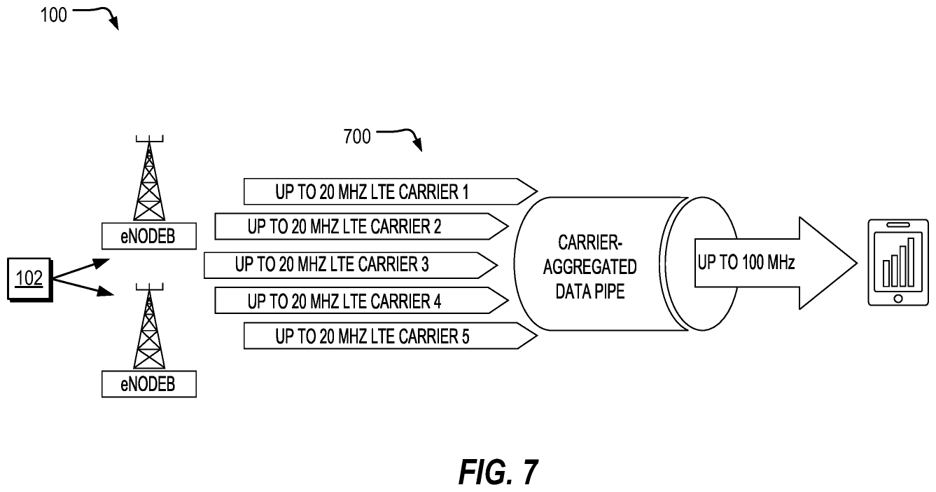

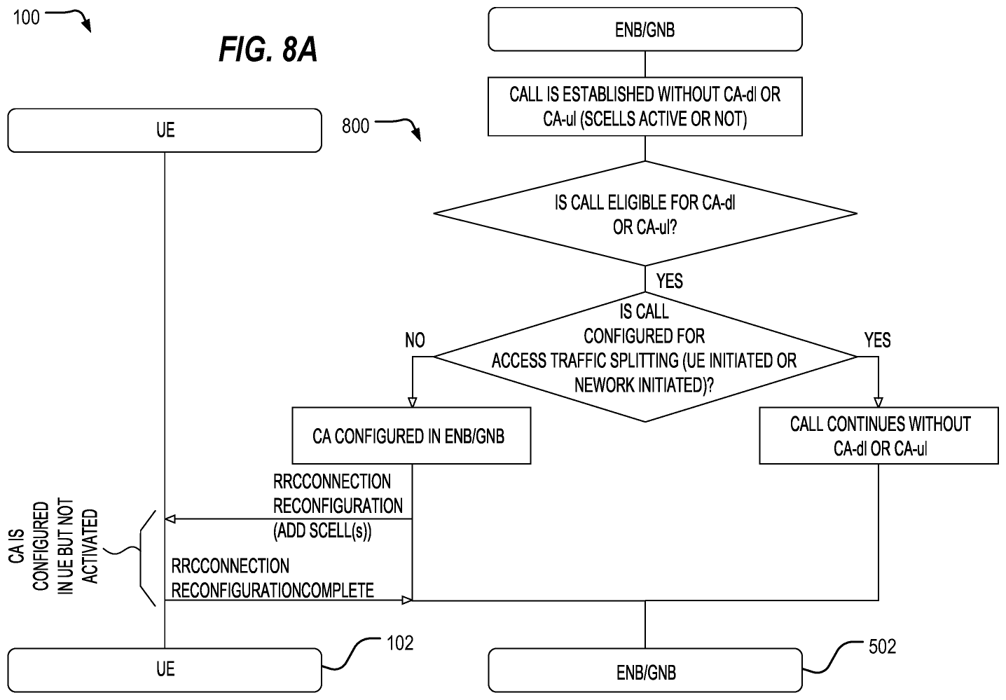

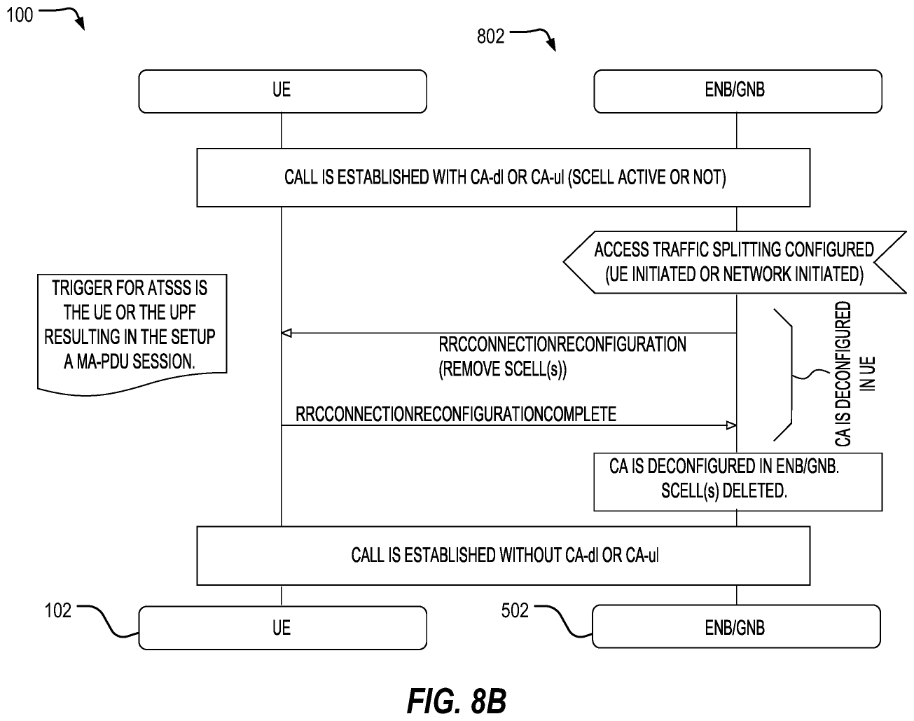

For instance, the system 100 can use one or more 3GPP features (e.g., Release 16) to ensure efficient use of network resources and conserve UE battery life, which can include relaxed radio resource management (RRM) measurements. An explicit awareness of the ATSSS capability of the ATSSS capability signaling UE 102 can help the network further optimize the network resources assigned for ATSSS capable devices by customizing UE specific features, parameters, and/or thresholds, such as Carrier Aggregation (CA) Configuration and Activation, as discussed in greater detail below regarding FIGS. 7-8B. While the power saving potential of any of the individual enhancements may seem trivial, when taken together, the effect can be quite significant. The power savings available through these measures can depend on many factors, including the specific device, network, and other factors like features activated and parameters configured. The UECapabilityInformation 504 can be a troubleshooting tool for test engineers. If some UE fails in some protocol testing (e.g., such as Handover, a specific type of measurement, or so forth), a test engineer can check this information from the UE and check if the enhancements/features are supported. As such, consolidating the MUSIM and/or ATSSS Capability and enhancements supported by the UE as part of the framework can aid in troubleshooting.

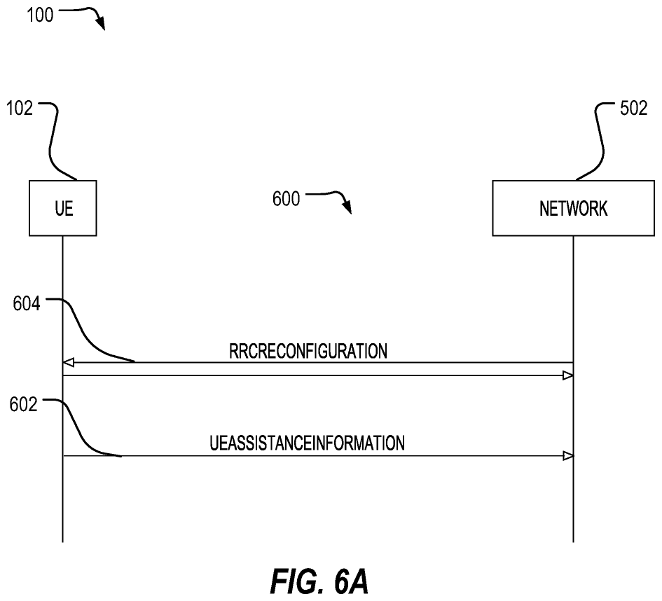

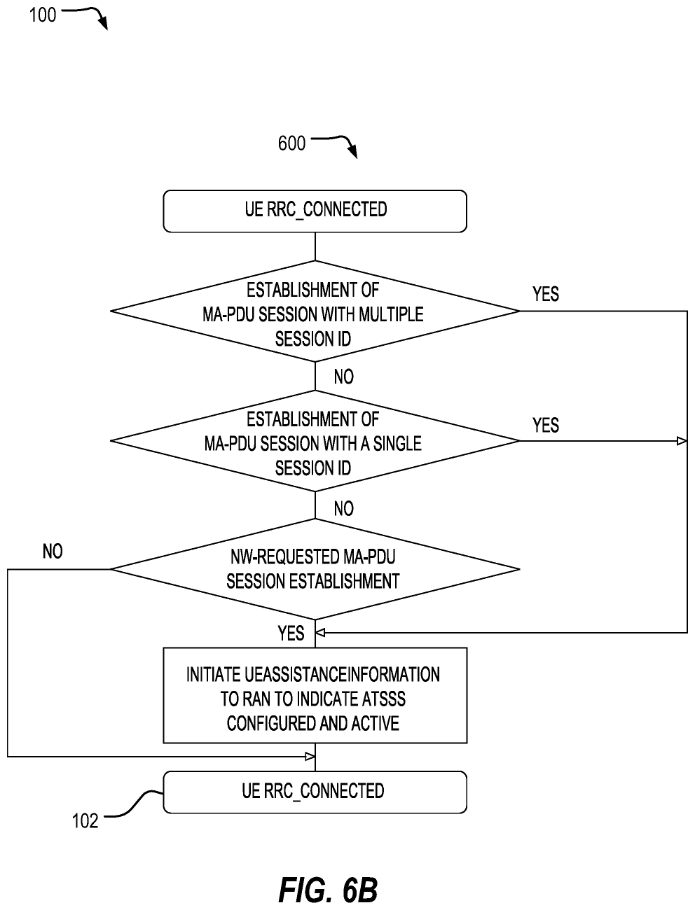

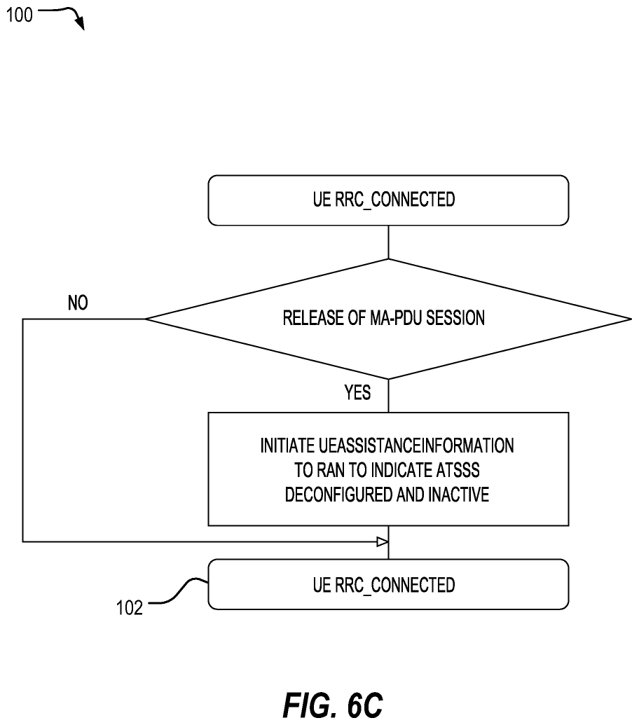

FIGS. 6A-6C illustrate the example system 100 which can leverage enhancements to the UE Assistance Information Capability framework 600 (e.g., as described in 3GPP TS 38.331: Section 5.7.4) to indicate the ATSSS capability of the ATSSS capability signaling UE 102 to the RAN.

For instance, FIG. 6A depicts a UE Assistance Information message 602 sent, from the ATSSS capability signaling UE 102 to the RAN node(s), in response to an RRCReconfiguration message 604. In some scenarios, the ATSSS capability signaling UE 102 uses this procedure to inform the network of one or more UE device parameters, such as its delay budget report carrying desired increment/decrement in the connected mode DRX cycle length; its overheating assistance information; its IDC assistance information; its preference on DRX parameters for power saving; its preference on the maximum aggregated bandwidth for power saving; its preference on the maximum number of secondary component carriers for power saving; its preference on the maximum number of MIMO layers for power saving; its preference on the minimum scheduling offset for cross-slot scheduling for power saving; its preference on the RRC state; configured grant assistance information for NR sidelink communication; or its preference in being provisioned with reference time information. In some instances, enhancements to any of these piece of UE-related information can result in the ATSSS capability signaling UE 102 informing the network of its ATSSS Configuration and/or Activation status (e.g., upon establishment of a MA-PDU session 112). Additionally or alternatively, this information can be used to signal the ATSSS deconfiguration and/or deactivation status upon release of a MA-PDU session 112 for the UE 102.

In some scenarios, the ATSSS capability indicating UE 102 can be capable of providing ATSSS configuration and activation information in an RRC_CONNECTED procedure, which may be configured to initiate in response to one or more Multi-Access PDU session related triggers. These triggers can include one or more of successful establishment of Multi-Access PDU session 112 with multiple PDU Session IDs; successful establishment of Multi-Access PDU session 112 with single PDU Session ID; or Network Requested MA-PDU Session Establishment (e.g., based on TS 23.793 Section 6.2.2, Section 6.2.3, Section 6.2.4).

FIG. 6B depicts an example flowchart of the system 100 indicating UE ATSSS Configuration and Activation status to RAN. The UE 102 capable of providing ATSSS configuration and activation information in RRC_CONNECTED may initiate the procedure if it was configured to do so, upon successful request for release of MA-PDU session TS 23.793 Section 6.2.7). Additionally, FIG. 6C depicts a Flowchart to indicate UE ATSSS DeConfiguration and DeActivation status to RAN.

In some examples, the operations performed by the system 100 discussed herein can result in various benefits to the network(s) of the multi-RAN network environment 104 and/or the UE 102. For instance, using the features of release 16 to indicate the ATSSS capabilities can result in efficient use of network resources and conserve UE battery life. The explicit awareness of the ATSSS capability of the device can help the network further optimize the network resources assigned for ATSSS capable devices by customizing UE specific features, parameters, and thresholds.

FIG. 7 illustrates an example of the system 100 including a carrier aggregation (CA) procedure 700 based on the network receiving the indication of ATSSS capabilities from the ATSSS capability indicating UE 102.

In some examples, CA addresses the support of higher data rates and utilization of fragmented spectrum holdings for 3GPP LTE. CA can combine more than one component carrier together, either in the same or different bands to increase the bandwidth available and in this way increase the capacity of the link assigned to a single user. CA can use frequency division duplex (FDD) techniques and/or time division duplex techniques (TDD).

Furthermore, in some scenarios, an LTE-Advanced UE (e.g., the ATSSS capability signaling UE 102) can be allocated downlink (DL) and/or uplink (UL) resources on the aggregated resource including one or two or more Component Carriers (CC). Additionally, R8/R9 UEs can be allocated resources on any ONE of the CCs. The CCs can be of different bandwidths.

In some examples, the system 100 can implement CA using Intra-Band and/or Inter-Band Aggregation alternatives. For instance, CA can be used to increase the bandwidth by combining multiple intra-band or inter-band Carriers in Uplink or Downlink, and thereby increase the peak bitrates. CA UE throughput can be much higher than signal carrier, due to additional carrier, frequency selection and scheduling gain and high category UE gain. In some instances, CA configuration/deconfiguration is performed on the RRC level. CA activation/deactivation can be performed on the MAC layer. Moreover, with CA performed at a medium access control (MAC layer), a packet data convergence protocol (PDCP) and a radio link control (RLC) can be unaware of whether a certain packet will be transmitted in the PCell or in the SCell. CA procedures impact the RAN node(s) (eg. eNodeB and/or gNodeB) and UEs in in 5Gs environments.

In some scenarios, the changes CA introduces at the physical layer are complex, especially the additional complexity in the design of the UE's radio frequency (RF) front-end implementation. With the introduction of carrier aggregation, asymmetric uplink and downlink allocations can be used, driven by different numbers of component carriers in the uplink and downlink signals, the different bandwidths of component carriers that can be aggregated and the resulting combinations of component carrier number and bandwidth in an aggregated signal. The complexity of the UE's radio frequency (RF) front-end implementation can vary greatly, depending on which type(s) of carrier aggregation are supported, with contiguous carrier aggregation being the least complex.

Furthermore, Access Traffic Splitting of ATSSS can provide Network Aggregation and CA can provide Spectrum (Component Carrier) Aggregation. Both Access Traffic Splitting and Carrier Aggregation can provide the unique capability of providing higher peak rates and increased cell coverage by aggregation of different network components of the system 100. They can be applied independently in both the Uplink and Downlink. That said, in some instances, CA can be expensive on the UE battery life. Additionally, implementing CA can result in reduction in Network Capacity in the Secondary Cells, and a corresponding reduction of Network Capacity (e.g., a maximum number of RRC_CONNECTED Users on the Secondary Cells).

To address these aspects of the system 100, mechanism for UEs that are CA capable can support Access Traffic Splitting to conserve battery life and optimize network (3GPP) resource utilization.

FIG. 8A depicts the example system 100 including an Updated procedure 800 when Call is eligible for CA-dl or CA-ul. For instance, the scenario in FIG. 8A can occur when a call is established without CA and subsequently the UE 102 is configured for Access Traffic Splitting (either UE initiated or Network Initiated).

FIG. 8B depicts the example system 100 including an Updated procedure 802 when a call is established with CA-dl or CA-ul. The scenario of FIG. 8B can occur when the Call is established with CA and the UE is configured for Access Traffic Splitting (e.g., either UE initiated or Network Initiated). Benefits that may result from the first Updated procedure 802 and/or the second Updated procedure 804 can include, use of network resources and conservation of UE battery life. The technology disclosed herein can leverage making Access Traffic Splitting and Carrier Aggregation mutually exclusive to help further optimize the network resources and conserve UE battery life.

When taken together, the power savings realized by the individual enhancements can be quite significant. The power savings available through these measures is dependent on many factors, including the specific device, network, and other factors like features activated and parameters configured. The techniques disclosed herein may be applied by manufacturers and/or vendors of phones, modems, Network Equipment, MNOs, and so forth. Additionally, the technology may be implemented in accordance with green technology and energy efficiency directives. Some standards impacted and/or related to the technology disclosed herein can include 3GPP TS 23.401, TS 24.301, TS 23.501, TS 23.502 TS 23.503; TS 38.300, TS 38.306, TS 38.331, TS 36.300, TS 36.306, TS 36.331

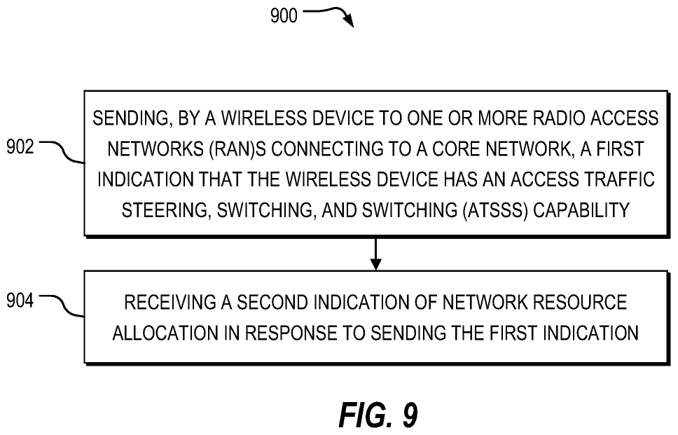

FIG. 9 illustrates an example method 900 for performing network operations based on an indication of ATSSS capabilities from the UE 102. The method 900 depicted in FIG. 9 can be performed by any of the systems(s) 100 depicted in FIGS. 1-8B.

In some examples, at operation 902, the method 900 can send, by a wireless device to one or more radio access networks (RAN)s connecting to a core network, a first indication that the wireless device has an ATSSS capability. The first indication can be included in at least one of: a UECapabilityInformation message of a user equipment (UE) Capabilities Transfer procedure; or a UEAssistanceInformation message of a UE assistance information capability procedure. At operation 904, the method can receive a second indication of network resource allocation in response to sending the first indication.

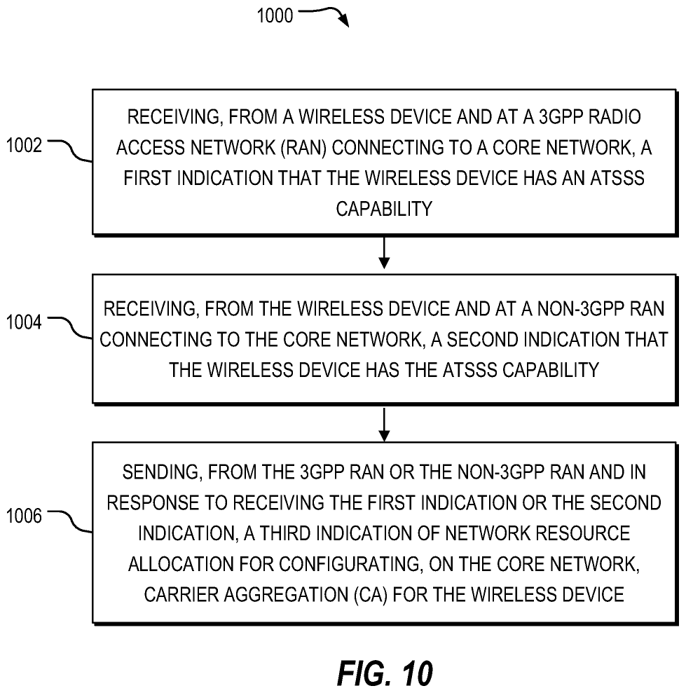

FIG. 10 illustrates an example method 1000 for performing network operations based on an indication of ATSSS capabilities from the UE 102. The method 1000 depicted in FIG. 9 can be performed by any of the systems(s) 100 depicted in FIGS. 1-8B.

In some examples, at operation 1002, the method 1000 can receive, from a wireless device and at a 3GPP RAN connecting to a core network, a first indication that the wireless device has an ATSSS capability. At operation 1004, the method 1000 can receive, from the wireless device and at a non-3GPP RAN connecting to the core network, a second indication that the wireless device has the ATSSS capability. At operation 1006, the method 1000 can send, from the 3GPP RAN or the non-3GPP RAN and in response to receiving the first indication or the second indication, a third indication of network resource allocation for configurating, on the core network, carrier aggregation (CA) for the wireless device.

It is to be understood that the specific order or hierarchy of steps in the method(s) discussed and/or depicted in FIGS. 9 and 10 and throughout this disclosure are instances of example approaches and can be rearranged while remaining within the disclosed subject matter. For instance, any of the operations discussed in FIGS. 9 and 10 and and/or depicted throughout this disclosure may be omitted, repeated, performed in parallel, performed in a different order, and/or combined with any other of the operations discussed in FIG. 9 or 10 and/or depicted throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method of allocating network resources, the method comprising:
sending, by a wireless device to one or more radio access networks (RAN)s connecting to a core network, a first indication that the wireless device has an Access Traffic Steering, Switching, and Switching (ATSSS) capability, the first indication being included in at least one of:
a first message of a user equipment (UE) Capabilities Transfer procedure; or
a second message of a UE assistance information capability procedure; and
receiving a second indication of network resource allocation in response to sending the first indication.

2. The method of claim 1, further comprising receiving, by the wireless device, a UECapabilityEnquiry message, wherein the first indication that the wireless device has the ATSSS capability is included in a UECapabilityInformation message responsive to the UECapabilityEnquiry message.

3. The method of claim 1, further comprising receiving, by the wireless device, an RCCReconfiguration message, wherein the first indication that the wireless device has the ATSSS capability is included in a UEAssistanceInformation message responsive to the RCCReconfiguration message.

4. The method of claim 1, wherein:
the one or more RANs includes a first RAN of a multi-access packet data unit (MA PDU) session and a second RAN of the MA PDU session, the first RAN being a third generation partnership program (3GPP) RAN and the second RAN being a non-3GPP RAN.

5. The method of claim 4, wherein sending the first indication of the ATSSS capability is responsive to releasing the wireless device from the MA PDU session.

6. The method of claim 1, wherein the first indication of the ATSSS capability includes an indication the wireless device has an Access Traffic Steering capability.

7. The method of claim 6, wherein the first indication the wireless device has the Access Traffic Steering capability includes an indication the wireless device has multi-path transmission control protocol (MPTCP) functionality for transmission control protocol (TCP) traffic.

8. The method of claim 7, wherein the first indication the wireless device has the Access Traffic Steering capability includes an indication the wireless device has ATSSS-lower level (LL) functionality for transmission control protocol (TCP) traffic, user datagram protocol (UDP) traffic, or Ethernet traffic.

9. The method of claim 6, wherein the first indication of the ATSSS capability includes an indication the wireless device has an Access Traffic Splitting capability.

10. The method of claim 7, wherein the first indication of the ATSSS capability includes one or more additional information elements (IE)s included in a UECapabilityInformation message based on a first standard of third generation partnership program (3GPP) TS 38.331: Section 5.6.1 or a second standard of long term evolution (LTE) 36.331 Section 5.6.3.

11. The method of claim 10, wherein the wireless device includes multiple universal subscriber identity modules (USIM)s, and the one or more additional IEs consolidate ATSSS features for the multiple USIMS.

12. The method of claim 1, wherein receiving the second indication of network resource allocation includes performing Carrier Aggregation (CA) configuration or activation for the wireless device.

13. A method of allocating network resources, the method comprising:
receiving, from a wireless device and at one or more radio access networks (RAN)s connecting to a core network, a first indication that the wireless device has an Access Traffic Steering, Switching, and Switching (ATSSS) capability, the first indication being included in at least one of:
a UECapabilityInformation message of a user equipment (UE) Capabilities Transfer procedure; or
a UEAssistanceInformation message of a UE assistance information capability procedure; and
sending a second indication of network resource allocation in response to receiving the first indication.

14. The method of claim 13, further comprising:
sending, from the one or more RANs and to a session management function (SMF) or a policy control function (PCF), a query to check policies of a service data unit (SDU) or a packet data unit (PDU) data flow for the wireless device; and
determining, by the one or more RANs or an Access & Mobility Function (AMF), the ATSSS capability for the wireless device based at least partly on a response to the query.

15. The method of claim 13, wherein the first indication of the ATSSS capability is included in a FeatureGroupIndicator (FGI) or a Feature Set of the UECapabilityInformation message.

16. The method of claim 13, wherein the first indication of the ATSSS capability includes an indication of a Performance Measurement Function (PMF) at a user plane function (UPF) associated with ATSSS-lower level (LL) functionality.

17. The method of claim 13, wherein the first indication is included in the UECapabilityInformation message with one or more of:
an increment/decrement in a connected mode discontinuous reception (DRX) cycle length;
overheating assistance information;
in-device coexistence (IDC) assistance information;
a preference of a DRX parameter;
a preference of a maximum aggregated bandwidth;
a preference of a maximum number of secondary component carriers;
a preference of a maximum number of multiple-input multiple-output (MIMO) layers;
a preference of a minimum scheduling offset for cross-slot scheduling;
a preference of a radio resource control (RRC) state;
configured grant assistance information for a new radio (NR) sidelink communication; or
a preference of being provisioned with reference time information.

18. A method of allocating network resources, the method comprising:
receiving, from a wireless device and at a 3GPP radio access networks (RAN) connecting to a core network, a first indication that the wireless device has an Access Traffic Steering, Switching, and Switching (ATSSS) capability;
receiving, from the wireless device and at a non-3GPP RAN connecting to the core network, a second indication that the wireless device has the ATSSS capability; and
sending, from the 3GPP RAN or the non-3GPP RAN and in response to receiving the first indication or the second indication, a third indication of network resource allocation for configuring, on the core network, carrier aggregation (CA) for the wireless device.

19. The method of claim 18, wherein the first indication or the second indication includes an RRCConnectionReconfigruationComplete message indicating the ATSSS capability.

20. The method of claim 19, further including, in response to the RRCConnectionReconfigruationComplete message indicating the ATSSS capability, activating an ATSSS feature instead of a CA feature for a call associated with the wireless device.
